(19) United States
(12) Patent Application Publication
(10) Pub. No.: US 2025/0282262 A1
(43) Pub. Date: Sep. 11, 2025

(54) VEHICLE SEAT WITH A LONGITUDINAL ADJUSTMENT LOCK

(71) Applicant: Brose Fahrzeugteile SE & Co. Kommanditgesellschaft, Coburg, Coburg (DE)

(72) Inventor: Andreas PAULS, Grub am Forst (DE)

(21) Appl. No.: 18/860,567

(22) PCT Filed: Apr. 24, 2023
(86) PCT No.: PCT/EP2023/060563

§ 371 Date: Dec. 24, 2024

(30) Foreign Application Priority Data
Apr. 26, 2022 (DE) 10 2022 204 027.9

(51) Int. Cl. B60N 2/12

(52) U.S. Cl. CPC B60N 2/12

(57) ABSTRACT

A vehicle seat comprises a longitudinal adjustment device with a first adjustment part which can be adjusted relative to a second adjustment part along a longitudinal direction, a locking device by means of which the first adjustment part can be arrested relative to the second adjustment part, and an operating part movably mounted on the first adjustment part, by actuation of which the locking device can be unlocked, a seat part which is supported on the second adjustment part via the first adjustment part, and an adjustment lock with a locking element mounted on the operating part and a mating locking element fixed to the second adjustment part, wherein the locking element can be locked to the mating locking element in at least one position of the first adjustment part relative to the second adjustment part.

### CROSS REFERENCE TO RELATED APPLICATIONS

The present application is a U.S. National Phase of International Application No. PCT/EP2023/060563 entitled “VEHICLE SEAT WITH A LONGITUDINAL ADJUSTMENT LOCK,” and filed on Apr. 24, 2023. International Application No. PCT/EP2023/060563 claims priority to German Patent Application No. 10 2022 204 027.9 filed on Apr. 26, 2022. The entire contents of each of the above-listed applications are hereby incorporated by reference for all purposes.

### BACKGROUND

This solution relates to a vehicle seat.

In dependence on the respective site of use, i.e. in particular the shape and size of a door opening of a vehicle with the vehicle seat, it may be desirable to clear an entry region as large as possible. What is conceivable therefor are vehicle seats which combine e.g. folding forward of a backrest with unlocking of a longitudinal adjustment device in order to bring the vehicle seat into an easy-entry position. However, as a result of its weight force, the vehicle seat in such cases often is automatically moved back from the easy-entry position in the direction of a position of use, e.g. when the vehicle is standing uphill. This can make entry more difficult and can also involve a risk of injury.

DE 10 2020 205 108 A1 describes a vehicle seat with a locking portion integrated on a kinematic lever for comfortably locking and unlocking the vehicle seat in the easy-entry position.

A vehicle seat which is longitudinally shiftable by tilting its backrest is described in DE 36 08 827 A1. The function of this vehicle seat, however, is based on a relatively complex lever construction.

It is and object of the underlying the proposed solution to indicate a vehicle seat which has as simple a construction as possible.

This object is achieved by a vehicle seat having features as described herein.

Accordingly, a vehicle seat comprises a longitudinal adjustment device with a first adjustment part, which is adjustable relative to a second adjustment part along a longitudinal direction, a locking device by means of which the first adjustment part can be arrested relative to the second adjustment part, and an operating part movably mounted on the first adjustment part, by actuation of which the locking device can be unlocked, and a seat part which is supported on the second adjustment part via the first adjustment part. Furthermore, the vehicle seat comprises an adjustment lock with a locking element mounted on the operating part and a mating locking element fixed to the second adjustment part. In at least one position of the first adjustment part relative to the second adjustment part, the locking element can be locked to the mating locking element.

This construction allows locking e.g. in a forward position of the vehicle seat with particularly few additional parts, which due to the simple construction can also be of the easily manufacturable type, so that a vehicle seat of particularly simple construction becomes possible.

For example, locking of the locking element to the mating locking element can be released by actuating the operating part. This allows a particularly intuitive operation. The operating part also obtains a dual function which contributes to the simple construction.

The vehicle seat can comprise a kinematic device by means of which the seat part is movable between at least one position of use to be occupied and a position moved forwards along the longitudinal direction. The kinematic device optionally connects the seat part to the longitudinal adjustment device. The kinematic device can comprise one or more pivot levers. Such a kinematic device provides for an easy-entry position moved forwards particularly far for a particularly comfortable entry.

The kinematic device can be locked e.g. in the position of use. An inadvertent adjustment of the seat part can thereby be prevented.

Optionally, the vehicle seat comprises an unlocking mechanism, by actuation of which the kinematic device and/or the longitudinal adjustment device, in particular the kinematic device and the longitudinal adjustment device jointly, can be unlocked. This provides for a particularly intuitive and easy operation.

The kinematic device can include a multiple joint. For example, the kinematic device forms a four-bar linkage or a seven-bar linkage. The kinematic device for example can comprise at least two pivot levers, which each are formed to be pivotable with the seat part and the first adjustment part.

Optionally, the locking element is formed spring-elastic. For locking to the mating locking element, the locking element can snap into place thereon in a simple way. This provides for a simple and at the same time particularly robust configuration.

For example, the locking element is configured in the form of a leaf spring. Such a locking element can be manufactured particularly easily.

Furthermore, the mating locking element can include an insertion bevel for the locking element. The e.g. spring-elastic locking element can slide along the same in a particularly simple way for locking. Alternatively, it can also be provided that the locking element is rigid and/or includes an insertion bevel and that the mating locking element is of spring-elastic design.

Optionally, the locking element includes an eyelet. It can be provided that the mating locking element can lockingly engage into the eyelet. This provides for a particularly robust and safe engagement of the mating locking element.

The locking element can be attached to an arm of the operating part, in particular to an arm by means of which the locking device of the longitudinal adjustment device can be unlocked. This provides for a further simplification of the construction.

The vehicle seat furthermore can include an unlocking element pivotally mounted on the first adjustment part, via which the arm is operatively connected to the locking device of the longitudinal adjustment device. This provides for an effective power transmission.

The operating part in particular can include a manually actuatable handle portion. The handle portion can be of rod-shaped design. This allows a particularly easy manufacture and intuitive operation.

The operating part is e.g. pivotally mounted on the first adjustment part. This provides for a particularly simple mechanism.

Optionally, the operating part is pretensioned by means of a spring into a position in which the locking element can be locked to the mating locking element. It can thus be ensured that locking is effected in the easy-entry position.

The adjustment parts can be movable relative to each other along an adjustment path, wherein the locking element and the mating locking element are configured to lock the adjustment parts to each other at an end of the adjustment path. The vehicle seat thereby can be comfortably held in the end position. The adjustment parts in particular can be configured in the form of an upper rail and a lower rail. This provides for an easy-entry position moved forwards particularly far, which nevertheless snaps into place comfortably and by using few parts.

### BRIEF DESCRIPTION OF THE DRAWINGS

The idea underlying the solution will be explained in detail below with reference to the exemplary embodiment illustrated in the Figures. In schematic representations:

FIG. 1 shows a view of a vehicle seat with a seat part and a backrest.

FIG. 2 shows a view of a longitudinal adjustment device of the vehicle seat with an adjustment lock.

FIGS. 3-7 show views of a locking element and a mating locking element of the adjustment lock in various positions of the vehicle seat.

### DETAILED DESCRIPTION

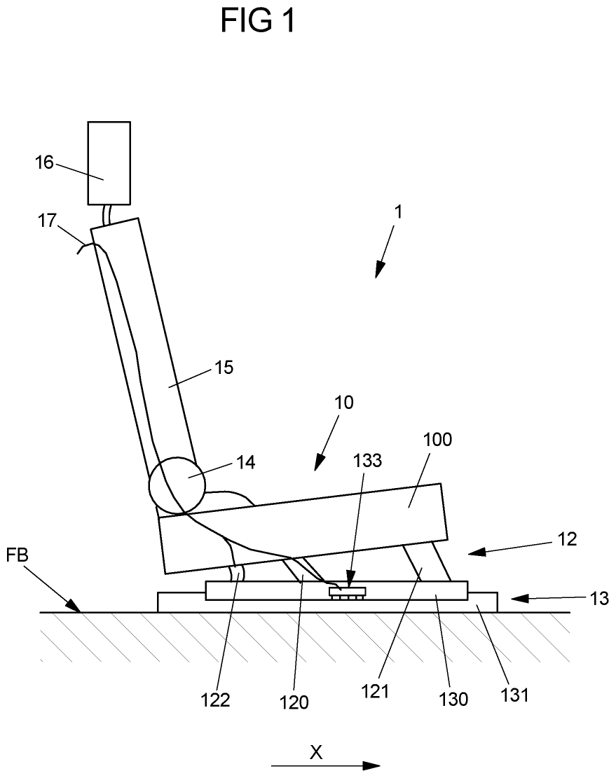

A vehicle seat 1 schematically shown in FIG. 1 includes a seat part 10 and a backrest part 15 with a head rest 16 pivotally arranged with respect to the seat part 10 via an arrangement of rotary fittings 14. A seat user can sit down on the seat part 10. Via the arrangement of rotary fittings 14 the backrest part 15 can be pivoted relative to the seat part 10 in order to adapt the tilt position of the backrest part 15 with respect to the seat part 10 and/or bring the backrest part 15 into a position pivoted forwards.

Such a vehicle seat 1 can be configured as a front seat in a vehicle. Such a vehicle seat 1 can, however, also be used e.g. as a rear seat, for example in a second seat row, in a vehicle.

In the illustrated example, the seat part 10 of the vehicle seat 1 is coupled to a longitudinal adjustment device 13 via a kinematic device 12. The longitudinal adjustment device 13 carries the seat part 10. As in the illustrated example the backrest part 15 is mounted on the seat part 10, the longitudinal adjustment device 13 thus also carries the backrest part 15. A weight force of the seat part 10 (and of the backrest part 15) and, if a seat user sits down on the vehicle seat 1, also a weight force of the seat user, hence is introduced into the longitudinal adjustment device 13 via the kinematic device 12.

Via the longitudinal adjustment device 13, the seat part 10 (jointly with the kinematic device 12 and the backrest part 15) can be connected to a vehicle floor FB of a vehicle and is connected to the same according to FIG. 1 in a longitudinally adjustable way. The longitudinal adjustment device 13 comprises a first adjustment part, here in the form of an upper rail 130 which is shiftably mounted on a second adjustment part, here in the form of a lower rail 131, along a longitudinal direction X. The lower rail 131 can be firmly connected to the vehicle floor FB and is firmly connected to the same according to FIG. 1. In the present case, the vehicle seat 1 comprises two of such rail pairs, one each on one side of the vehicle seat 1. By means of the longitudinal adjustment device 13 the vehicle seat is adjustable in the longitudinal direction X.

The longitudinal adjustment device 13 comprises a locking device 133 by means of which the upper rail 130 can be arrested relative to the lower rail 131, namely can be locked to the lower rail 131.

In the present case, an adjustment part, namely the upper rail 130, of the longitudinal adjustment device 13 jointly serves as a base for the kinematic device 12.

A locking device 122 of the kinematic device 12 secures the vehicle seat 1 in a position of use in which the seat user can sit down on the seat part 10. When this locking device 122 is released, kinematic levers 120, 121 of the kinematic device 12 can be pivoted relative to the upper rail 130 so that the vehicle seat 1 can be transferred from the position of use into a position moved forwards with respect thereto in order to provide an entry position. Via the kinematic levers 120, 121 the seat part 10 is connected to the upper rail 130 so as to be movable relative to the upper rail 130. Optionally, the kinematic device 12 also serves for adjusting the seat height and allows the setting of various positions of use.

As will yet be explained in detail below, the vehicle seat 1 can be transferred into an entry position by a pivotal movement by means of the kinematic device 12 and by a shifting movement by means of the longitudinal adjustment device 13. The entry position can also be referred to as an easy-entry position.

The vehicle seat 1 comprises an unlocking mechanism 17, which here is illustrated by way of example as an unlocking lever. An actuation of the unlocking mechanism 17 effects unlocking of the locking device 122 of the kinematic device 12 and of the locking device 133 of the longitudinal adjustment device 13. In the illustrated example a Bowden cable is provided, which can be pulled through the unlocking mechanism 17 in order to unlock both locking devices 122, 133. Then, the vehicle seat 1 can be pivoted and shifted forwards.

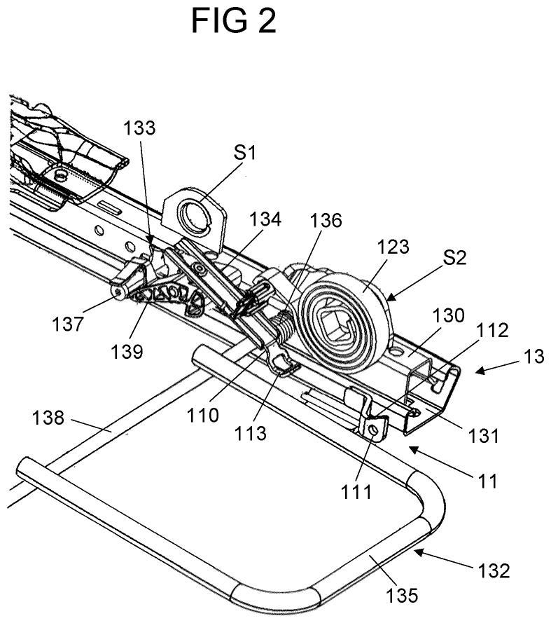

FIG. 2 shows two rails 130, 131 of the longitudinal adjustment device 13. At this point, it should be noted that FIG. 2 shows one of two sides of the vehicle seat 1, wherein the vehicle seat 1 comprises a second side, in particular a mirror-symmetrically constructed second side. The description of the side shown in FIG. 2 analogously applies for the second side of the vehicle seat 1 shown in FIG. 1.

The first kinematic lever 120 shown in FIG. 1, i.e. the rear kinematic lever 120 with respect to the longitudinal direction X, is pivotally mounted on the upper rail 130 on a rear swivel bearing S1. The second kinematic lever 121, i.e. the front kinematic lever 120 with respect to the longitudinal direction X, is mounted on the upper rail 130 so as to be pivotable about a front swivel bearing S2. Furthermore, the kinematic levers 120, 121 each are pivotally mounted on the seat part 10. The upper rail, the two kinematic levers 120, 121 and the seat part 10 jointly form a four-bar linkage.

The four-bar linkage of the kinematic device 12 is configured such that during the forward and backward displacement between the position of use and the easy-entry position the seat part 10 is first lifted and then lowered again. Therefore, the kinematic device 12 can also be referred to as “bunny hop kinematics”. This provides for a far displacement forwards into the easy-entry position. In the present case, this movement is supported by a pretensioned spring 123 which pretensions the seat part 10 in the direction of the easy-entry position. The spring 123 is configured in the form of a coil spring extended about a pivot axis defined by the front swivel bearing S2.

In the illustrated example, the locking device 133 of the longitudinal adjustment device 13 includes a comb which is movably, e.g. pivotally mounted on the upper rail 130 and can lockingly engage into holes at the lower rail 131 (see e.g. FIG. 1). The locking device 133 can be unlocked by means of a bolt 137. In the present case, the bolt 137 therefor can be displaced in a slot in the upper rail 130 so that the comb is lifted out of the holes and enables a relative movement of the rails 130, 131.

For unlocking the locking device 133 an unlocking element 139 is provided. The unlocking element 139 is pivotally mounted on the upper rail 130 at a pivot axis. A lever arm of the unlocking element 139 is operatively connected to the bolt 137. A pivotal movement of the unlocking element 139 lifts the bolt 137 so that the locking of the rails 130, 131 is released. The unlocking element 139 furthermore has a further lever arm.

To effect a pivotal movement of the unlocking element 139, the vehicle seat 1 comprises an operating part 132. The operating part 132 is pivotally mounted on the upper rail 130. It includes a handle portion 135. The handle portion 135 is formed by a bent rod and can also be referred to as a “towel bar”. A seat user can actuate the handle portion 135, more exactly: pull the same upwards. The operating part 132 furthermore comprises an arm 134. In the present case, the operating part 132 furthermore comprises a rod 138 to which the handle portion 125 and the arm 134 are attached, wherein other configurations also are conceivable. The rod 138 is straight. Via the rod 138, the handle portion 135 and the arm 134 are firmly connected to each other and pivotally mounted on the upper rail 130. A spring 136 is spring-elastically pretensioned and urges the operating part 132 against the unlocking position.

The arm 134 of the operating part 132 cooperates with the unlocking element 139, namely in the present case with the further lever arm of the unlocking element 139. When the arm 134 of the operating part 132 pivots relative to the upper rail 130, the arm 134 presses against the further lever arm of the unlocking element 139 so that the same is pivoted.

The vehicle seat 1 furthermore comprises an adjustment lock 11 with a locking element 110 mounted on the operating part 132 and a mating locking element 111 attached to the second adjustment part, here to the lower rail 131, wherein the locking element 110 can be locked to the mating locking element 111 in at least one position of the first adjustment part, i.e. here of the upper rail 130, relative to the second adjustment part, i.e. to the lower rail 131.

The locking element 110 in the present case is mounted on the arm 134 of the operating part 132. The locking element 110 is configured in the form of a spring, namely in the illustrated example in the form of a leaf spring, wherein a coil spring or another type of spring would also be conceivable. The locking element 110 flatly rests on the arm 134. It is attached to the arm 134 in the region of an end of the arm 134. At the opposite end, the locking element 110 includes an eyelet 113. In the region of the eyelet 113 the locking element 110 is bent, namely in the present case is U-shaped.

The mating locking element 111 is attached to the lower rail 131. In the present case, it is bent in an S-shaped manner. The mating locking element 111 has an open end. This open end can be locked to the locking element 110. The mating locking element 111 therefor includes an insertion bevel 112 along which the locking element 110 can slide during a movement of the upper rail 130 relative to the lower rail 131. The locking element is bent spring-elastically. During a movement into the easy-entry position the eyelet 113 is lifted when sliding along the insertion bevel 112 and snaps back as soon as it is pushed over the open end of the mating locking element 111. The eyelet 113 thereby comes into locking engagement with the mating locking element 111. The locking element 110 and the mating locking element 111 are configured to lock the rails 130, 131 to each other at the end of the adjustment path.

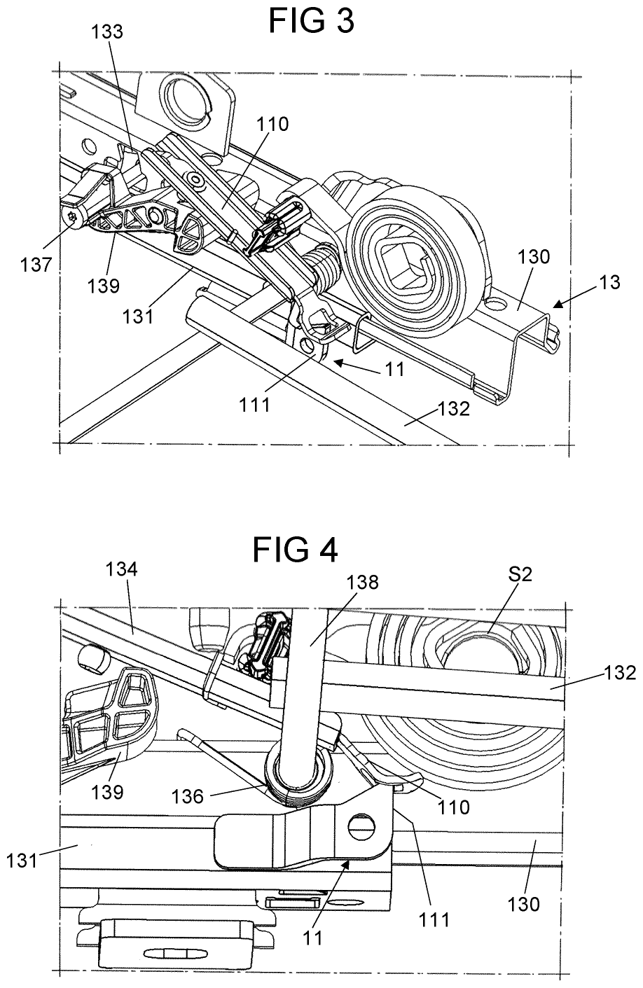

This position is shown in FIGS. 3 and 4. The eyelet 113 is in engagement with the mating locking element 111, so that a displacement of the upper rail 130 relative to the lower rail 131 back towards the position of use is blocked. The eyelet 113 abuts against the open end of the mating locking element 111 and thus prevents a further movement.

When the vehicle seat 1 now is to be displaced again from the forward position, the easy-entry position, back into the position of use, it is sufficient to actuate the operating part 132. This can be effected manually at the handle portion 135. Optionally, the unlocking mechanism 17 is configured to pivot the operating part 132.

FIG. 5 shows the operating part 132 in a raised position as compared to FIGS. 3 and 4. Furthermore, the position of the locking element 110 is shown with this position of the operating part 132. The locking element 110, concretely the eyelet 113 of the locking element 110, is lifted from the mating locking element 111 and out of engagement with the same.

Due to this unlocking, the upper rail 130 with the part of the vehicle seat 1 mounted thereon can be shifted relative to the lower rail 131 from the forward position back to the position of use.

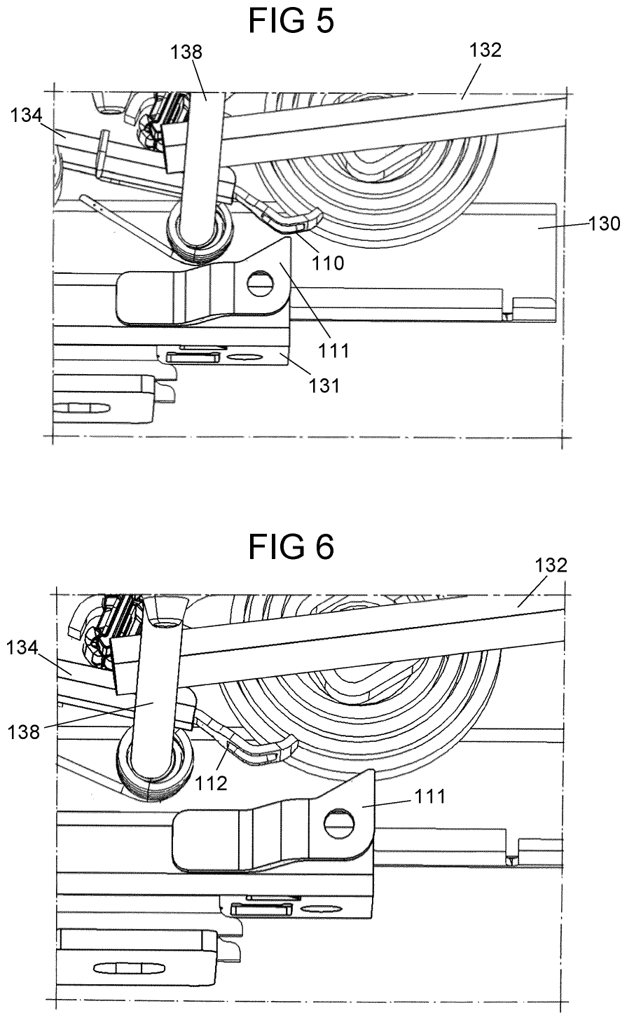

FIG. 6 shows a position in which the upper rail 130 with the part of the vehicle seat 1 mounted thereon already has been shifted relative to the lower rail 131 to a certain extent from the forward position back towards the position of use.

Thus, a locking of the locking element 110 to the mating locking element 111 can be released in a simple way by actuating the operating part 132.

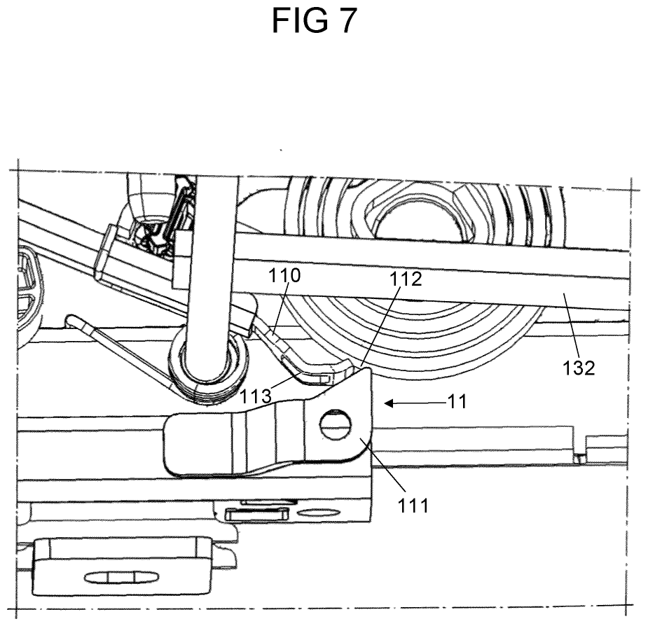

FIG. 7 finally shows the position during a renewed displacement of the vehicle seat 1 forwards into the easy-entry position, in which the locking element 110 impinges on the insertion bevel 112 of the mating locking element 111 when the operating part 132 is not actuated. Proceeding therefrom, a further forward displacement of the upper rail 130 effects that the eyelet 113 slides along the insertion bevel 112 and then snaps into place at the rigid mating locking element 111.

The operating part 132 is pretensioned by means of the spring 136 into a position in which the locking element 110 can be locked to the mating locking element 111.

Due to the described adjustment lock 11, the number of components can be kept particularly small. Furthermore, the assembly is particularly easy and no additional bearing points are necessary. Painting of individual parts also can be omitted.

It should be mentioned that alternatively the locking element 110 conversely might be of rigid design, while the mating locking element 111 would be of spring-elastic design, e.g. also in the form of a leaf spring.

### LIST OF REFERENCE NUMERALS

1 vehicle seat
10 seat part
11 adjustment lock
110 locking element
111 mating locking element
112 insertion bevel
113 eyelet
12 kinematic device
120 first kinematic lever
121 second kinematic lever
122 locking device
123 spring
13 longitudinal adjustment device
130 first adjustment part (upper rail)
131 second adjustment part (lower rail)
132 operating part
133 locking device
134 arm
135 handle portion
136 spring
137 bolt
138 rod
139 unlocking element
14 rotary fitting arrangement
15 backrest part
16 headrest
17 unlocking mechanism
FB vehicle floor
S1, S2 swivel bearing
X longitudinal direction

1. A vehicle seat, comprising:
a longitudinal adjustment device with a first adjustment part which can be adjusted relative to a second adjustment part along a longitudinal direction, a locking device by means of which the first adjustment part can be arrested relative to the second adjustment part, and an operating part movably mounted on the first adjustment part, by actuation of which the locking device can be unlocked,
a seat part which is supported on the second adjustment part via the first adjustment part, and
an adjustment lock with a locking element mounted on the operating part and a mating locking element fixed to the second adjustment part, wherein the locking element can be locked to the mating locking element in at least one position of the first adjustment part relative to the second adjustment part.

2. The vehicle seat according to claim 1, wherein a locking of the locking element to the mating locking element can be released by actuating the operating part.

3. The vehicle seat according to claim 1, further comprising a kinematic device by means of which the seat part is movable between at least one position of use to be occupied and a position moved forwards along the longitudinal direction.

4. The vehicle seat according to claim 3, wherein the kinematic device can be locked in the position of use.

5. The vehicle seat according to claim 4, further comprising an unlocking mechanism by actuation of which the kinematic device and the longitudinal adjustment device can be jointly unlocked.

6. The vehicle seat according to claim 3, wherein the kinematic device forms a multiple joint.

7. The vehicle seat according to claim 1, claims, wherein the locking element is of spring-elastic design.

8. The vehicle seat according to claim 7, wherein the locking element is configured in the form of a leaf spring.

9. The vehicle seat according to claim 1, wherein the mating locking element includes an insertion bevel for the locking element.

10. The vehicle seat according to claim 1, wherein the locking element includes an eyelet into which the mating locking element can lockingly engage.

11. The vehicle seat according to claim 1, wherein the locking element is attached to an arm of the operating part, by means of which the locking device of the longitudinal adjustment device can be unlocked.

12. The vehicle seat according to claim 11, further comprising an unlocking element pivotally mounted on the first adjustment part, via which the arm is operatively connected to the locking device of the longitudinal adjustment device.

13. The vehicle seat according to claim 1, wherein the operating part includes a manually actuatable handle portion.

14. The vehicle seat according to claim 1, wherein the operating part is pivotally mounted on the first adjustment part.

15. The vehicle seat according to claim 1, wherein the operating part is pretensioned by means of a spring into a position in which the locking element can be locked to the mating locking element.

16. The vehicle seat according to claim 1, wherein the adjustment parts are movable relative to each other along an adjustment path, wherein the locking element and the mating locking element are configured to lock the adjustment parts to each other at an end of the adjustment path.
